(19) United States
(12) Patent Application Publication
(10) Pub. No.: US 2012/0080896 A1
(43) Pub. Date: Apr. 5, 2012

(54) PNEUMATICALLY CONTROLLED GRASPING DEVICE

(75) Inventor: Giuseppe MAFFEIS, Roncadelle (Brescia) (IT)

(73) Assignee: GIMATIC S.p.A.

(21) Appl. No.: 13/267,106

(22) Filed: Oct. 6, 2011

Related U.S. Application Data
(62) Division of application No. 12/611,301, filed on Nov. 3, 2009.

(30) Foreign Application Priority Data
Nov. 20, 2008 (IT) BS 2008 A 000209

(51) Int. Cl. B25J 15/02

(52) U.S. Cl. 294/195; 294/192; 294/198

(57) ABSTRACT

A pneumatically controlled grasping device to grasp and handle items or bodies provided with a graspable member. A supporting sleeve (16, 36) internally delimits an intermediate space (23, 43) contiguous to a distal opening and a guide chamber (23′, 43′) connected to a source of fluid under pressure. In the intermediate space a gripper device (21,41) is mounted, facing the distal opening and designed to engage with the graspable member. In the guide chamber a control piston (22, 42) is housed movable into a first position which corresponds to an activation or deactivation of the gripper device by the fluid under pressure, and to a second position which corresponds to the deactivation or activation of the gripper device, by at least a flexible reaction element (27, 47). The gripper device can be equipped to grasp the graspable member from the outside or from inside when it has a cavity.

### CROSS REFERENCE TO RELATED APPLICATIONS

This application is a divisional application under 37 CFR 1.53(b) of pending prior application Ser. No. 12/611,301 filed Nov. 3, 2009 and claims the benefit of priority under 35 U.S.C. §119 of Italian patent application BS 2008 A 000209 filed Nov. 20, 2008. The entire contents of each application is hereby incorporated by reference in its entirety.

### FIELD OF THE INVENTION

The invention relates to a pneumatically controlled grasping device to grasp, thrust and/or position items, bodies or tools or fixtures by any type of manipulator.

### BACKGROUND OF THE INVENTION

Devices able to grasp and rapidly release an item or body to be handled by a robot or handling equipment, with the aim of reducing time and consequently operating or working costs in various sectors, such as presswork, robotics, automation and assembling, are already well known.

### SUMMARY OF THE INVENTION

An object of the invention is however to provide an innovative pneumatically controlled grasping device for use in the above mentioned range, simple to make and reliable, incorporating a gripper type grasping device for gripping an intermediate element preliminarily applied to the item, body or the like, which may be handled from the outside or inside, when hollow.

The object is achieved with a pneumatically controlled grasping device for grasping and handling items or bodies provided with a graspable member, comprising a support sleeve with at least a proximal connecting means to connect it to a manipulator and a fluid source, typically air, under pressure and a distal axial opening. The grasping device is characterized in that the sleeve forms an internal, intermediate space adjacent to the distal opening and a guide chamber connected to the fluid source under pressure, and in that in the intermediate space a gripper means is mounted facing the distal opening and designed to engage with the graspable member, and in the guide chamber a control piston is housed movable in a first position, corresponding to either an activation on or a deactivation of the gripper means by a fluid under pressure fed to said chamber, and in a second position which corresponds to either a deactivation or activation on of the gripper means by at least an elastic reaction element.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded view of the components of a device for grasping a ball-grip from the outside;

FIG. 2 is a perspective view of the device in FIG. 1 as assembled and connected to a ball-grip to be grasped;

FIG. 3 is a side view of the assembled device, but with the ball-grip to be grasped separated;

FIG. 4 is an axial sectional view of the device according to arrows A-A in FIG. 3 with grasper jaws open;

FIG. 5 is a sectional view analogous to the one in FIG. 4, but with the device in an intermediate grasping, or release, position, of a respective ball-grip;

FIG. 6 is a sectional view analogous to the one in FIG. 5, but with the device in the grasping position of a respective ball-grip to be grasped;

FIG. 7 is an exploded view of the components of a device for grasping the inside of the hollow ball-grip;

FIG. 8 is a side view of the device in FIG. 7 as assembled with regard to a separated ball-grip to be grasped;

FIG. 9 is an axial sectional view of the device according to arrows B-B in FIG. 3 in an inoperative position;

FIG. 10 is a side view of the device engaged to the hollow ball-grip; and

FIG. 11 is an axial sectional view according to arrows C-C in FIG. 10.

### DESCRIPTION OF THE PREFERRED EMBODIMENTS

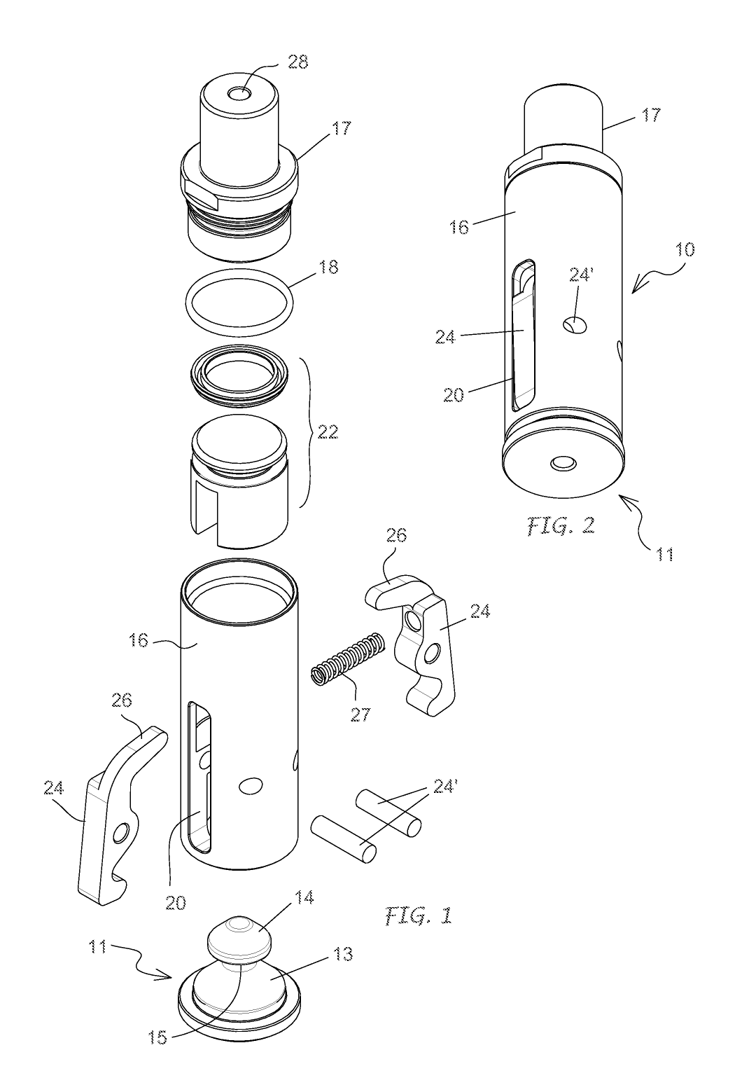

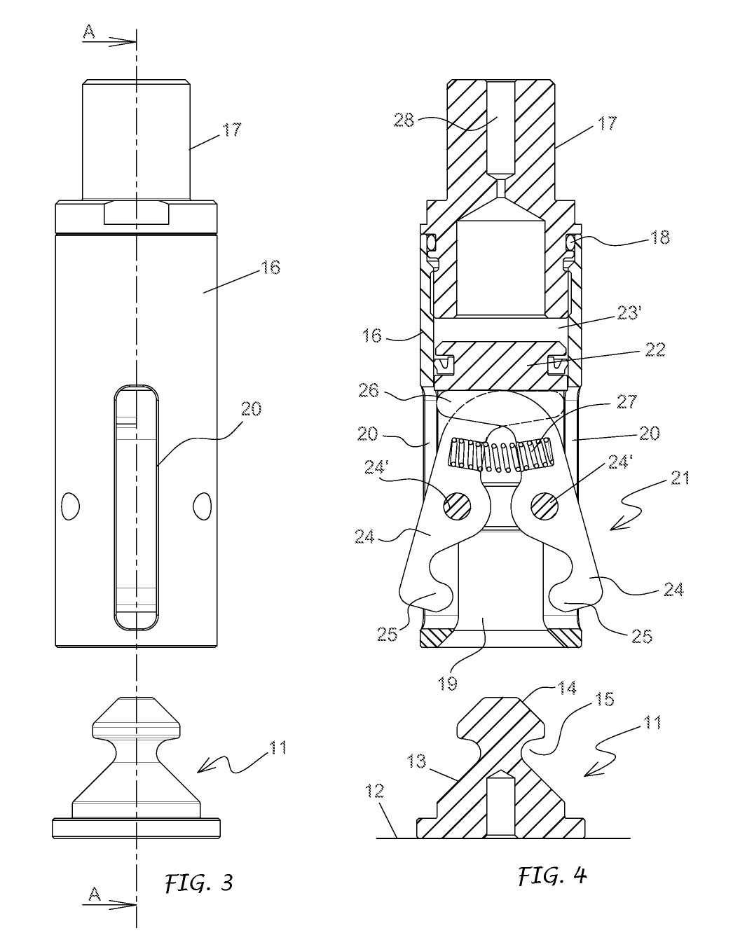

Referring to the drawings in particular, FIGS. 1-6 represent a grasping device 10 suitable for gripping from the outside, for example, a graspable ball-grip 11 preliminarily fixed to an item or a body 12 to be handled and/or positioned. This ball-grip 11 has a tapered leg 13 overhung mushroom like by a head 14 also tapered, delimiting between them a peripheral graspable groove 15.

The grasping device 10 comprises a supporting sleeve 16, basically cylindrical, having a proximal end to which a fitting 17 is screwed with the interposition of a seal 18, a distal end with an axial opening 19 and, laterally, two longitudinal slots 20 on opposite sides.

Internally the supporting sleeve 16 is provided with a gripper means 21 and a control piston 22 associated therewith. The gripper means 21 is positioned in an intermediate space 23 of the sleeve 16 on a level and in line with the lateral slots 20, whereas the piston 22 is housed and movable in a guide chamber 23′ delimited by the supporting sleeve 16 at a level between the proximal fitting 17 and the intermediate space 23.

The gripper means 21 is made up of two complementary gripper arms 24, each assembled and oscillating on a respective pin 24′. Each arm of the gripper 24 has a terminal gripper nose 25 opposite to the one of the other arm, the gripper noses being in the vicinity of the distal opening 19 of the supporting sleeve 16 and configured depending on the shape of the groove 15 around the graspable ball-grip 11. At the opposite end of the one provided with a gripper nose 25, each gripper arm 24 has an extension or appendix 26 facing towards and in contact with the control piston 22 through a slot at the base of the latter. Between the two gripper arms 24 a spring 27 is positioned, designed to maintain the terminal gripper noses 25 close to one another in an operating grasping position and to move and maintain the control piston 22, by means of the extensions or appendixes 26, in a retracted position towards the proximal fitting 17. The piston 22, however, is moveable forwards towards the gripper means 21 by a fluid under pressure, typically air, fed to the chamber 23 through a hole 28 made in the proximal fitting 17 so as to cause, through the extension or appendix 26 of the gripper arms 24, the terminal gripper noses 25 to move away and therefore open the gripper means.

The proximal fitting 17 usually also acts as a means for forming a rigid connection of the grasping device 10 to any manipulator member or equipment—not shown.

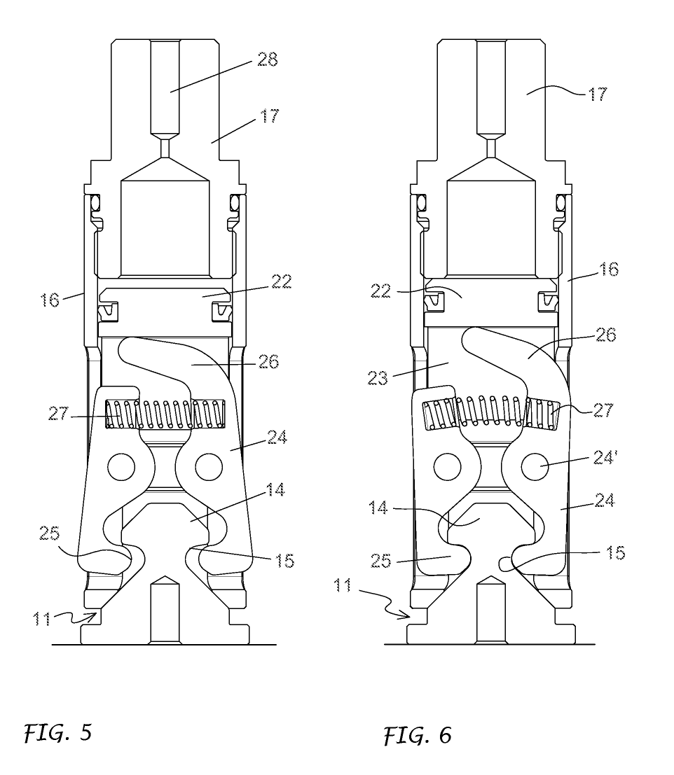

Practically, therefore, the gripper means 21, thanks to the relative spring 27, normally remains in the active position, that is to say closed, whereas the control piston 22 remains in a retracted position. However when the device is moved near the graspable ball-grip 11, the gripper noses 25 of the gripper arms 24 in contact with the tapered head 14 of the ball-grip open wide first, see FIG. 5, then close automatically in the groove 15, grasping in this way the ball-grip, see FIG. 6, and, by means of this, the item or body 12 the ball-grip has been fixed to. In this way the item or body 12 involved, not only will it be grasped and conveniently handled, but also may be pulled and pushed, consequently positioned according to needs with regards to a preset “zero” position, by means of an appropriate management of the movements of the device or manipulator carrying the grasping device.

Then, to release the graspable ball-grip 11 and with it the item or body 12 it is associated with, it is sufficient to supply the fluid under pressure to the chamber 23′ in order to move the control piston 22 forward and cause the gripper arms to turn and therefore the opening of the gripper means in opposition to the spring 27 as shown in FIG. 4.

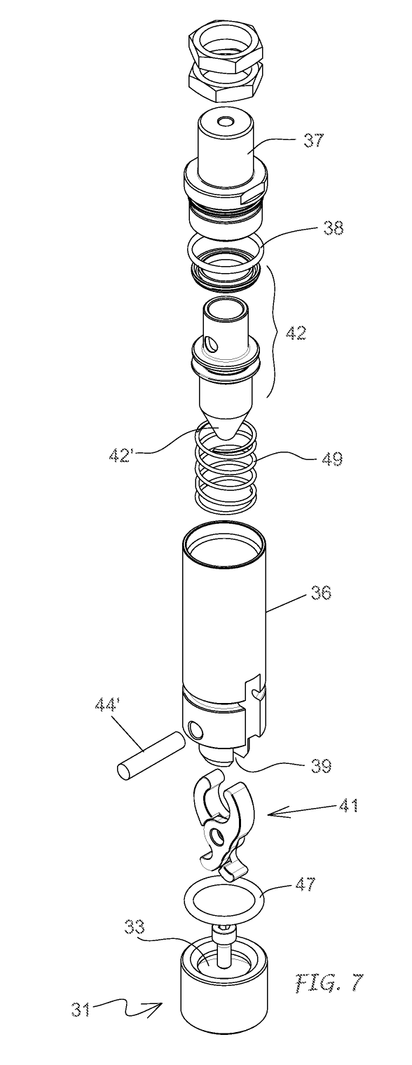

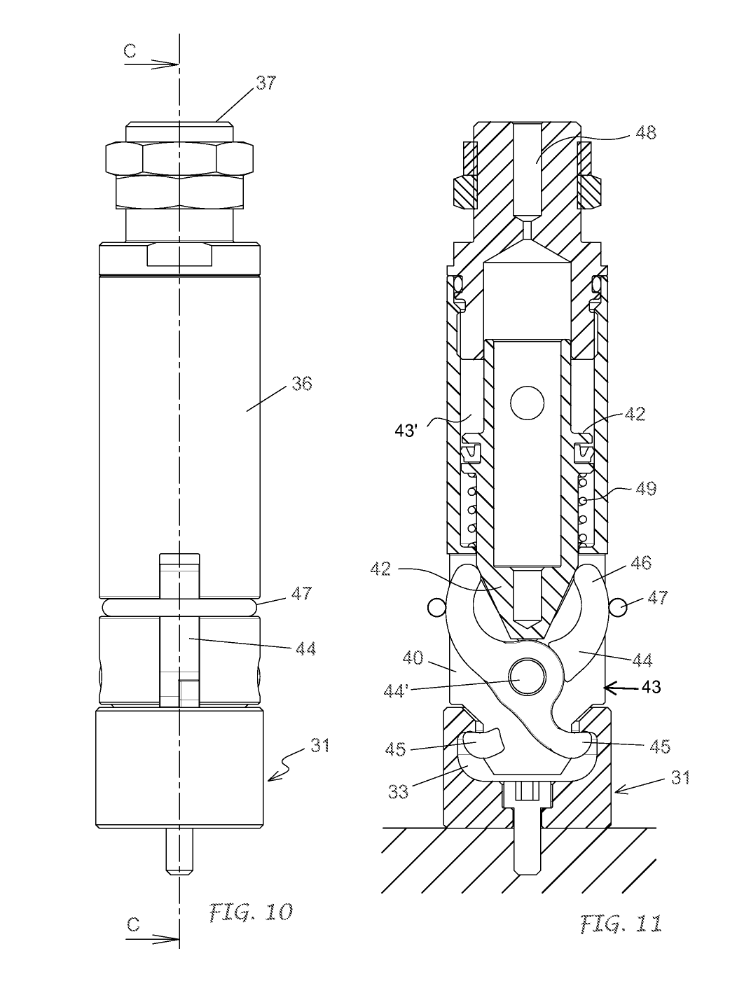

According to the embodiment of FIGS. 7-11, the grasping device 30 is suitable on the contrary to grasp a ball-grip 31 from the inside, fixed in advance to an item or a body 32 to handle and/or position it and having in this case a front graspable groove 33.

The grasping device 30 comprises a basically cylindrical supporting sleeve 36, having a proximal end to which a fitting 37 is screwed with the interposition of a seal 38, a distal tapered end with an opening 39 and, laterally, two longitudinal slots 40 on opposite parts. Internally, the supporting sleeve 36 holds a gripper means 41 and a control piston 42 associated therewith. The gripper means 41 is positioned in an intermediate space 43 on a level and in line with the lateral slots 40, whereas the piston 42 is housed and slides in a chamber 43′ delimited by the supporting sleeve 36 at a level between the proximal fitting 37 and the lateral slots 40.

In this case, the gripper means 41 is made up of two crossed gripper arms 44, assembled and turning on a common pin 44′ and each one having a terminal gripper nose 45. The gripper noses are facing in opposite directions, towards the outside, near the distal opening 39 of the supporting sleeve 36 and configured to be able to fit in the cavity 33 of the graspable ball-grip 31.

From the opposite part of their gripper noses 45, the gripper arms 44 each have an extension or appendix 46 facing towards and in contact with the control piston 42. In one groove around the supporting sleeve 36 is mounted a flexible ring 47, which engages with the gripper arms 44 so as to normally maintain their terminal gripper noses 45 near to each other in a released idle position and to maintain the extensions or appendixes 46 of the gripper arms in contact with the piston 42.

The control piston 42 has a conical portion 42′ that comes between the extensions and appendixes 46 of the gripper arms 44 to control the activation and deactivation of the latter with the help of the external flexible ring 47 and depending on the position of the piston in the guide chamber 43′. A spring 49 associated with the piston 42 works so as to maintain it in a retracted position towards the proximal fitting 37, a position that corresponds to the release condition of the gripper means on the part of the flexible ring 47 engaging with gripper arms. Furthermore, the piston 42 can move forward towards the gripper means 41 by the fluid under pressure, typically air, fed to the chamber 43′ through a hole 48 made in the proximal fitting 37 so as to cause, by means of its conical portion 42′ the opening of the extensions or appendixes of the gripper arms and consequently a grasper action on the part of the gripper noses 45.

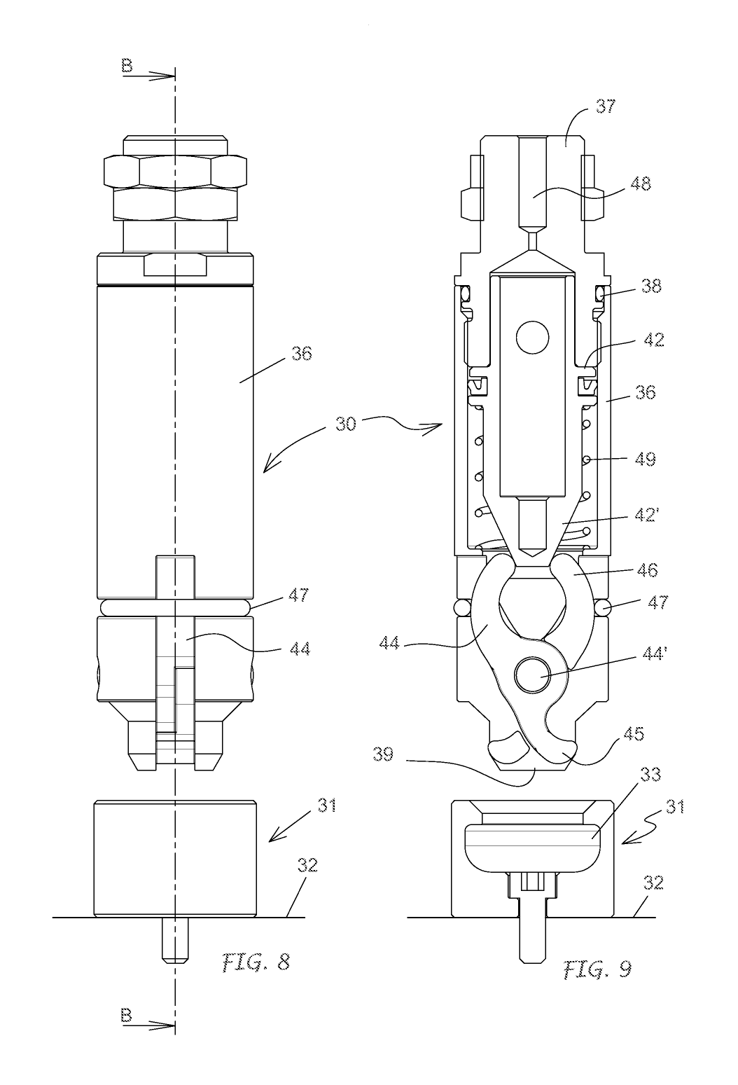

Respectively, as long as the control piston 42 is in the retracted position, the gripper means 41 remains in an idle position as in FIG. 9. Once the coupling device 30 has been drawn near the graspable ball-grip 41 by any manipulator, the gripper means can be activated by feeding the fluid under pressure to the chamber 43′ so as to move the piston 42 forward and cause, by its conical portion 42′, the rotation of the gripper arms in that their gripper noses 45, by distancing themselves one from the other, engage inside the cavity 33 of the ball-grip 42 as shown in FIG. 11.

To release the hollow ball-grip 41 and with it the item or body 42 it is associated with, it is sufficient to remove the fluid under pressure from the chamber 43′. The return spring 48 will now push the piston back, while the flexible external ring 47 will return the gripper means to the idle starting position.

While specific embodiments of the invention have been shown and described in detail to illustrate the application of the principles of the invention, it will be understood that the invention may be embodied otherwise without departing from such principles.

What is claimed is:

1. A pneumatically controlled grasping device for grasping and handling items or bodies provided with a graspable member, the device comprising:
a support sleeve with at least a proximal connecting means to connect said support sleeve to a manipulator and a fluid source, typically air, under pressure and a distal axial opening, said sleeve forming an internal, intermediate space adjacent to said distal opening and a guide chamber connected to the fluid source under pressure;
a gripper means mounted in said intermediate space, said gripper facing the distal opening for engaging said graspable member;
a control piston housed in said guide chamber, said control piston being movable between a first position, corresponding to either an activation or a deactivation of said gripper means by a fluid under pressure fed to said chamber, and a second position which corresponds to either a deactivation or activation of said gripper means by at least an elastic reaction element.

2. A grasping device according to claim 1, wherein the graspable member has a truncated cone shank dominated by a head which is also truncated cone shape to form a circular peripheral groove between said shank and said cone, said gripper means being arranged to engage from the outside in the peripheral groove of said graspable member when the gripper means is in an active position.

3. A grasping device according to claim 2, wherein said gripper means comprises two complementary gripper arms, each of said gripper arm oscillating on a respective pin, each of said gripper arms having, on one side, a terminal gripper nose opposite to that of another one of said gripper arms and an extension or appendix on the opposite side, said extension or appendix being adjacent to the distal opening of the supporting sleeve, an extension or appendix (26) facing towards said control piston, said extension or appendix being in contact with the control piston.

4. A grasping device according to claim 3, wherein said elastic reaction element is a spring placed between the gripper arms to hold said terminal gripper noses normally close together in an active grip position and to move the control piston into a retracted position towards the proximal connection means, said piston being moved by a fluid under pressure towards the extensions or appendixes of the gripper arms such that the gripper means is switched off.

5. A grasping device according to claim 1, wherein the graspable member comprises a front gripper cavity, said gripper means being arranged to connect inside said front cavity of the graspable member when the gripper means is in the active position.

6. A grasping device according to claim 5, wherein said gripper means comprises two crossed gripper arms, assembled and turning on a common pin, wherein each gripper arm has, on one side, a terminal gripper nose adjacent to the distal opening of the support sleeve and, on the opposite side, an extension or appendix, said gripper noses facing in opposite directions towards the outside, wherein the opposite extensions or appendixes are facing towards and in contact with the control piston.

7. A grasping device according to claim 5, wherein a flexible ring is located around the supporting sleeve and engages with the gripper arms such that the terminal gripper noses are arranged close to one another in an idle gripper position and the extensions or appendixes of said gripper arms are in contact with the piston, said piston having a conical portion in contact with said extensions or appendixes such that the gripper arms turn and the activation of the gripper means when the piston is moved in one direction by the fluid under pressure, and the deactivation of the gripper means when the piston is moved in the opposite direction by a return spring associated with said piston.

8. A grasping device according to claim 1, wherein said gripper arms is in line with longitudinal splits or slots provided on opposite sides of the supporting sleeve.

9. A grasping device according to claim 1, wherein the proximal connecting means comprises a fitting with a portion fixed to a manipulator, and at least a fluid under pressure feed bore to the guide chamber of the piston.
